(19) United States
(12) Patent Application Publication
(10) Pub. No.: US 2012/0130869 A1
(43) Pub. Date: May 24, 2012

(54) METHOD AND SYSTEM FOR DISPLAYING FINANCIAL INFORMATION

(75) Inventors: Jaidev Shergill, New York, NY (US); Michele Serro, New York, NY (US); Shiv Bir Singh, New York, NY (US)

(73) Assignee: BUNDLE CORPORATION, New York, NY (US)

(21) Appl. No.: 12/951,483

(22) Filed: Nov. 22, 2010

(51) Int. Cl. G06Q 10/00

(52) U.S. Cl. 705/30

(57) ABSTRACT

Methods, systems and computer programs that display financial information are provided.

### BACKGROUND

The present application relates to computer programs for displaying financial information.

Several computer software programs have been designed that help a user track quantifiable financial information. See, e.g., U.S. Pat. Nos. 5,245,535, 6,012,044, 6,064,984, and 7,246,110; U.S. Patent Application Publications 20030014331, 20060143072, 20070174163, 20080235073, 20090144117, 20090216597, and 20090271287; and PCT Publications WO2002091225 and WO2002097561. Those programs generally display the quantifiable financial information as graphs on X-Y axes. Such a display can obfuscate the most important information for the user, particularly where the user is not mathematically oriented. The methods, systems and computer programs disclosed herein provide an alternative to those programs that has a more intuitive display, with other features to help the user understand the information.

### SUMMARY

Provided herewith are methods, systems and computer programs that display quantifiable financial information. In some embodiments, a method implemented using a processor, a memory and a display device for displaying financial information to a user is provided. The method comprises obtaining user finances information; obtaining financial category information for a plurality of financial categories; storing the user finances information and financial category information in the memory; determining a value for finances data in each of the plurality of financial categories using the processor, wherein the finances data of a financial category includes the user finances information in that category; and displaying the determined value of the finances data in each of the plurality of financial categories in the form of a shape for each value. In various embodiments, the size of each shape corresponds to the relative value of the finances data for the corresponding financial category such that a larger shape corresponds to a larger value. In additional embodiments, the shapes are not mathematically tied to a same axis.

Also provided is a system for displaying financial information to a user. The system comprises (a) a processor, wherein the processor (i) runs a software application that obtains financial category information for a plurality of financial categories, and user finances information categorized into the plurality of financial categories; and (ii) determines finances data in each of the plurality of financial categories. The finances data of a financial category in these embodiments includes the user finances information in that category. The system also comprises (b) a database coupled to the processor. The database resides in at least one memory and stores the user finances information and the financial category information. Additionally, the system comprises (c) a display coupled to the processor. The processor causes the finances data corresponding to the plurality of financial categories to be presented to the user on the display in the form of shapes of varying sizes. In various embodiments, the size of each shape corresponds to the relative value of the finances data for the corresponding financial category such that a larger shape corresponds to a larger value. Further, the shapes are not mathematically tied to a same axis.

Additionally provided is a computer program product to be used with a processor and a display. The computer program product comprises a computer usable medium comprising computer readable program code directing the processor to: obtain financial category information for a plurality of financial categories; obtain user finances information categorized into the plurality of financial categories; store the financial category information and the user finances information in a memory; determine a value for finances data in each of the plurality of financial categories, wherein the finances data of a financial category includes the user finances information in that category; and show on the display the determined value of the finances data in each of the plurality of financial categories in the form of a shape for each value. In various embodiments, the computer readable program code specifies that the size of each shape corresponds to the relative value of the finances data for the corresponding financial category such that a larger shape corresponds to a larger value; and the shapes are not mathematically tied to a same axis.

### BRIEF DESCRIPTION OF THE DRAWINGS

FIG. 1 is a flowchart of a method in accordance with an illustrated embodiment.

FIG. 2 is an output display of a method, system and computer program in accordance with an illustrated embodiment.

FIG. 3 is an output display of a method, system and computer program in accordance with an illustrated embodiment.

FIG. 4 is an output display of a method, system and computer program in accordance with an illustrated embodiment.

FIG. 5 is an output display of a method, system and computer program in accordance with an illustrated embodiment.

FIG. 6 is an output display of a method, system and computer program in accordance with an illustrated embodiment.

FIG. 7 is an output display of a method, system and computer program in accordance with an illustrated embodiment.

FIG. 8 is an output display of a method, system and computer program in accordance with an illustrated embodiment.

FIG. 9 is an output display of a method, system and computer program in accordance with an illustrated embodiment.

FIG. 10 is an output display of a method, system and computer program in accordance with an illustrated embodiment.

FIG. 11 is an output display of a method, system and computer program in accordance with an illustrated embodiment.

FIG. 12 is an output display of a method, system and computer program in accordance with an illustrated embodiment.

FIG. 13 is an output display of a method, system and computer program in accordance with an illustrated embodiment.

FIG. 14 is an output display of a method, system and computer program in accordance with an illustrated embodiment.

FIG. 15 is an output display of a method, system and computer program in accordance with an illustrated embodiment.

FIG. 16 is an output display of a method, system and computer program in accordance with an illustrated embodiment.

FIG. 17 is an output display of a method, system and computer program in accordance with an illustrated embodiment.

FIG. 18 is an output display of a method, system and computer program in accordance with an illustrated embodiment.

FIG. 19 is an output display of a method, system and computer program in accordance with an illustrated embodiment.

FIG. 20 is an output display of a method, system and computer program in accordance with an illustrated embodiment.

FIG. 21 is an output display of a method, system and computer program in accordance with an illustrated embodiment.

FIG. 22 is an output display of a method, system and computer program in accordance with an illustrated embodiment.

FIG. 23 is an output display of a method, system and computer program in accordance with an illustrated embodiment.

FIG. 24 is an output display of a method, system and computer program in accordance with an illustrated embodiment.

FIG. 25 is an output display of a method, system and computer program in accordance with an illustrated embodiment.

FIG. 26 is an output display of a method, system and computer program in accordance with an illustrated embodiment.

FIG. 27 is an output display of a method, system and computer program in accordance with an illustrated embodiment.

FIG. 28 is an output display of a method, system and computer program in accordance with an illustrated embodiment.

FIG. 29 is an output display of a method, system and computer program in accordance with an illustrated embodiment.

FIG. 30 is a flowchart illustrating a process for displaying and evaluating financial information.

### DETAILED DESCRIPTION

The terminology used herein is for describing particular embodiments only and is not intended to be limiting of the invention. As used herein, the singular forms “a”, “an” and “the” are intended to include the plural forms as well, unless the context clearly indicates otherwise. In addition, as referenced herein, a module is defined as hardware, software, and/or a combination thereof for performing a particular function. Software is defined as computer executable instructions including, but not limited to, object code, assembly code, and machine code. Hardware may include, but is not limited to, one or more processors/microprocessors, electronic circuitry, and other physical components. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof.

The methods, systems, and programs disclosed herein provides a way of processing and displaying quantifiable financial information using a display format that shows the quantifiable financial information as shapes sized relative to the size of the number that the shape represents. In some embodiments, the shapes are sized proportional to the size of the number that the shape represents. Such a display allows the user to perceive the quantifiable financial information more intuitively than the X-Y graphs more generally used.

In some embodiments, a method implemented using a processor, a memory and a display device for displaying financial information to a user is provided. The method comprises obtaining user finances information; obtaining financial category information for a plurality of financial categories; storing the user finances information and financial category information in the memory; determining a value for finances data in each of the plurality of financial categories using the processor, wherein the finances data of a financial category includes the user finances information in that category; and displaying the determined value of the finances data in each of the plurality of financial categories in the form of a shape for each value. In various embodiments, the size of each shape corresponds to the relative value of the finances data for the corresponding financial category such that a larger shape corresponds to a larger value. In additional embodiments, the shapes are not mathematically tied to a same axis.

As used herein, “financial category” is a category under which the user finances information may be categorized. Examples include a top level category, such as, for example, “spending” or “savings,” mid level categories, such as, for example, “shopping” or “credit cards”, and lower level categories, such as, for example, “groceries”, or “checking account.” The financial categories can be selected by the user, or by the processor according to preset parameters. Examples of financial categories are categories of (a) purchases, such as “clothing and shoes,” “electronics,” and “general shopping”; (b) debt, such as “short term debt” and “long term debt”; (c) savings, such as “bank savings accounts”; (d) investments, such as “mutual funds” and “bonds”; (e) loans, such as “mortgage” or “car loans”; (f) credit cards, such as “Chase VISA”, or (g) financial account, such as “IRA” or “401k”.

As used herein, “user finances information” is numerical information relevant to the user's finance that is categorized into financial categories, for example “$325” as a shopping expense. Examples of other relevant financial information includes the interest rate on a user loan or bond, and market activity (periodic or real time) of a user's publicly traded asset.

As used herein, “finances data” is a value determined for a financial category, for example, by calculating the sum of all the shopping values over one month. The finances data is a determined value based on the user finances information for a particular financial category or group of categories. In some embodiments, the finances data of a financial category is the sum of the user finances information in that category. In other embodiments, the finances data is determined using other relevant financial information affecting the value of finances within the financial category. The finances data can also be an average, e.g., a monthly average.

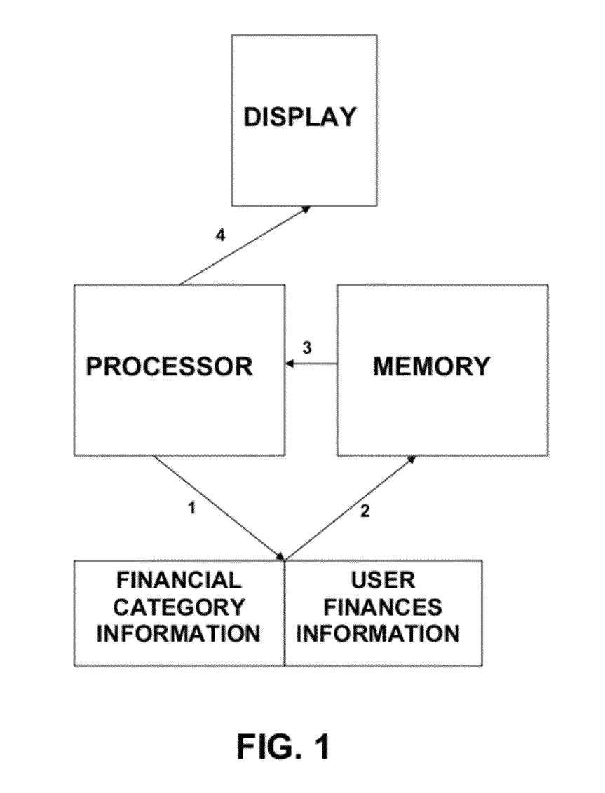

FIG. 1 provides a flowchart for these embodiments where financial information is being processed. In step 1, the processor obtains financial category information and user finances information. As indicated above, the numerical user finances information is categorized into a financial category so that, when the user finances information is obtained, the processor also determines which financial category the user finances information belongs to. In some cases, the financial category can be undefined or indeterminable from the financial information, such that a particular user finances information is uncategorized. Additionally, the finances data can be zero for a particular financial category, such that a particular financial category can have no user finances information or other relevant information associated with it.

In some embodiments, the processor requests input from the user, e.g., on the display device, by voice synthesizer, etc. In these embodiments, the user is queried about, e.g., purchases, income, payments, etc., along with which categories that the numerical information is associated with, e.g., shopping, salary, credit cards, etc.

In other embodiments, the user is queried by obtaining the financial category information and/or user finances information from a database, for example a bank database, e.g., from a website, that provides a statement of a financial account of the user, including, for example, debit card purchases, automatic payments, etc. In some embodiments, this information is automatically categorized into a financial category. In other embodiments, the processor queries the user as to which financial category the user finances information belongs.

In step 2 of the method illustrated in FIG. 1, the information obtained by the query is stored in a memory, where it may be retrieved by the processor (step 3) to calculate the finances data, which is then displayed on the display device (step 4).

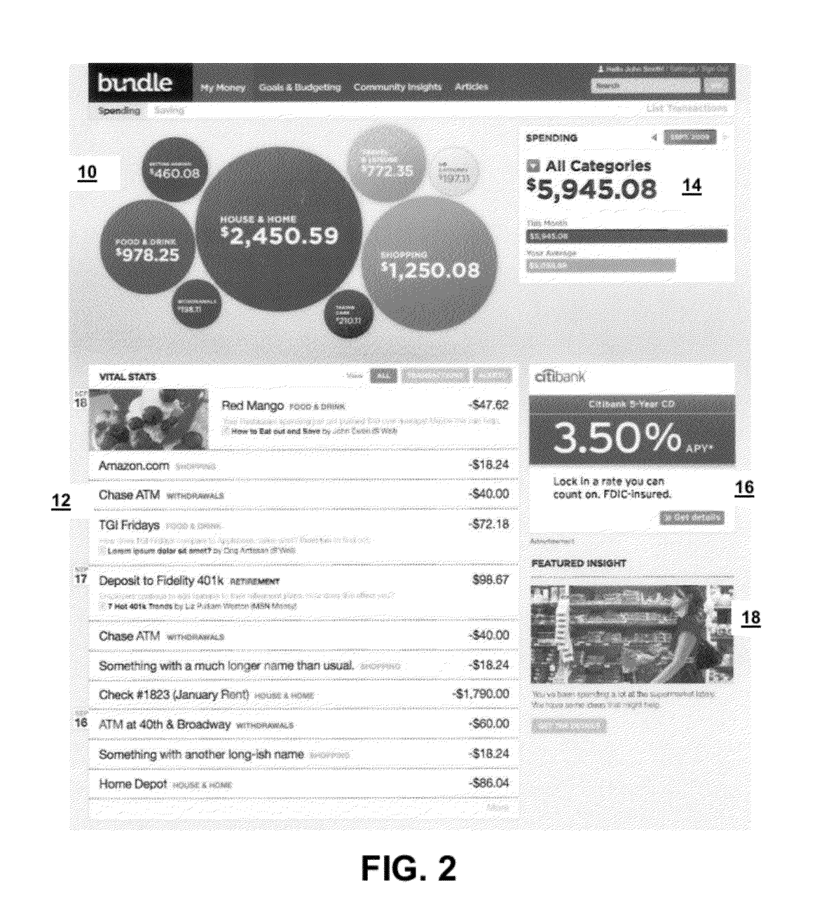

FIG. 2 shows a typical output on a display device for these embodiments. Along the top of the illustration are tabs for accessing various portions of the program. The My Money tab accesses a portion for analyzing personal spending and savings. The Goals & Budgeting tab provides a portion for establishing a budget and planning future goals. The Community Insights and Articles tabs provide access to information related to personal finances. This accessory information can include e.g., links to articles, statistical data, advice about financial choices, observations relating to the user's spending habits, or promotional materials. This can be general information relating to a particular subject, or information specific for the user, e.g., by analysis of retrieved statistics for the user's zip code, financial or demographic status, and/or the user's past buying habits, to provide information such as the top merchants for the user in a particular financial category or for all users in the demographic or zip code, e.g., shoe stores similar to stores previously patronized in the user's zip code, or most visited in the zip code.

The rest of the output is divided into five areas, marked 10, 12, 14, 16, and 18. Area 10 shows the shapes (here, circles) that correspond to the finances related information for the indicated financial categories (House & Home, Food & Drink, etc.). The illustrated embodiment shows these as categories of “Spending,” as indicated at the top left corner of area 10. The circles, which are labeled with the category and monetary value they represent, are proportional in size to the monetary values indicated therein. In some embodiments, the circles are different colors, where each category is assigned a different color. By assigning different colors, the user is able to more easily track the category being evaluated in various aspects of the method described below.

The displayed shapes are not limited to the circles shown in the exemplary output. In some embodiments, the shapes are represented by a single type of shape, for example a circle (as shown), an oval, a square, a rectangle, a triangle, a pentagon, a hexagon, a heptagon, an octagon, or a parallelogram. In other embodiments, the shapes are represented by more than one type of shape, for example any combination of a circle, an oval, a square, a rectangle, a triangle, a pentagon, a hexagon, a heptagon, an octagon, or a parallelogram.

In some embodiments, the shape is a rectangle having a length and a width, wherein the length of the rectangle increases and the width does not increase as the rectangle represents a larger value of finances data, i.e., a bar.

More than one type of shape can be utilized to indicate different types of data, e.g., a circle to represent financial categories of spending, and a bar to represent financial categories of investments.

In certain embodiments, the circumferences of the shapes can intersect or touch. In other embodiments, they do not intersect or touch.

As indicated in area 14, the output displayed relates to spending in September 2009. That area also shows a comparison of spending in the indicated month with an average monthly spending.

Area 12, labeled “Vital Stats,” shows user finances information for September 16-18, along with a description for each entry. Some of the entries also provide accessory information relating to the entry. For example, under the entry “Red Mango” (spending category “Food & Drink”) the display provides information relating to the Food & Drink category, that the user has spent more under that category in September than the average monthly expenditure for that category, and refers the user to a book that relates to saving money while eating out. The accessory information can be from any source, including from the World Wide Web. The accessory information can also be publicly available or from proprietary databases.

In some embodiments, the output for area 12 can be set by the user to include any number of days of transactions and any number of categories.

Advertisements from a sponsored vendor can also be displayed in the output for these embodiments, as provided in area 16. Additionally, area 18 provides other accessory information that can be related to finances data that is identified as an area of interest or concern (here, excess supermarket spending).

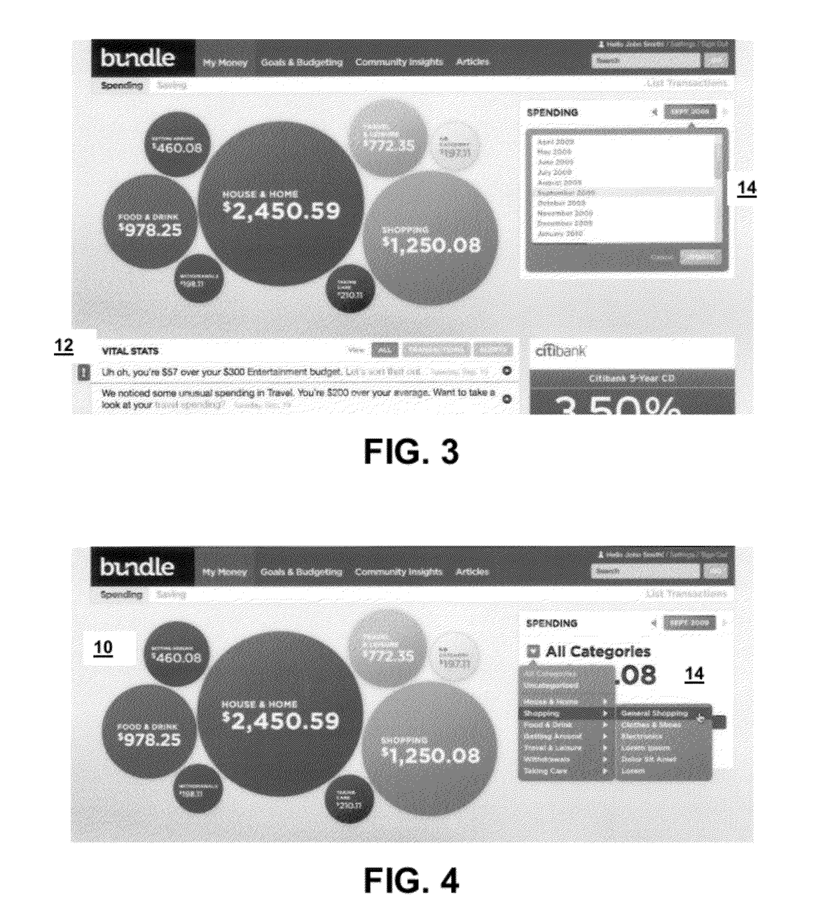

FIG. 3 shows a feature in area 14 where, by clicking on the “SEPT. 2009” label, a group of months is displayed, allowing easy movement between displays of finances data for various months. Additionally, in this view, the top of the “Vital Stats” section 12 provides two lines of accessory information. In one case, the accessory information is prompted by spending in a category (Travel) above the average, where the accessory information invites the user to further explore the Travel category. In the other case, the accessory information is prompted from spending that exceeds a budget.

A budget can be created for any demographic category and are particularly useful for categories of spending, as further described in co-pending patent application Ser. No. ______, entitled “Method and System for Budget Management,” filed concurrently and incorporated by reference in its entirety. In some embodiments, the user can set a budget for each category. In other embodiments, the program can “discover” a budget for a category by analyzing the user's past activity in that category, and/or by querying the user about the user's needs and financial situation and optionally evaluating the spending habits in that category by others in a similar financial situation, e.g., through the use of publicly available information or from proprietary databases.

In some embodiments, at least one of the financial categories is divided into a plurality of subcategories, where each subcategory represents a different financial division within the financial category comprising user finances information. These user financial subcategories can be any subcategory of any category of purchases, debt, savings, investments, loans, credit cards, or financial account. An example is a “Clothing & Shoes” subcategory for a “Shopping” category. The subcategories can also represent temporal divisions, for example day, month or year divisions of subcategories.

Various embodiments here further comprise (a) determining the value of finances data corresponding to each of the plurality of subcategories using the processor; and (b) displaying the values calculated under (a) in response to a user request, where the values are displayed in the form of a shape for each value. In these embodiments, the size of each shape corresponds to the relative value of the finances data corresponding to each of the plurality of subcategories such that a larger shape corresponds to a larger value. In some of these embodiments, the finances data of a subcategory is the sum of the user finances in that subcategory. In other embodiments, the calculation of the finances data of a subcategory utilizes the user finances information as well as other data, for example an interest rate.

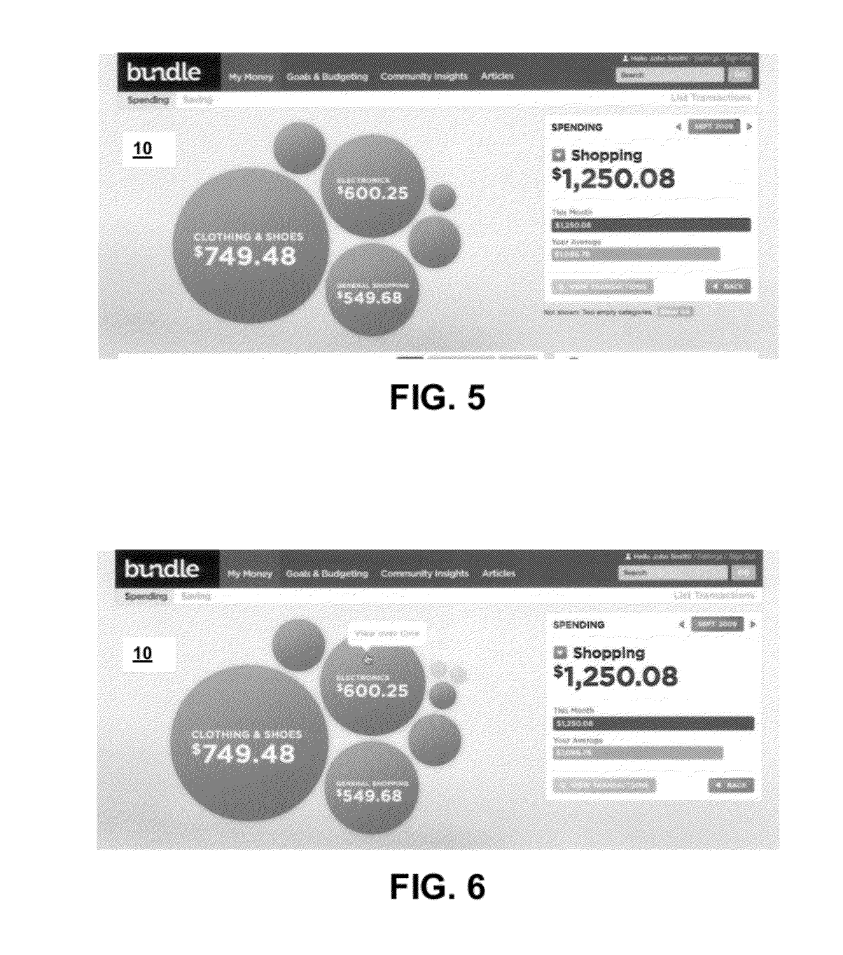

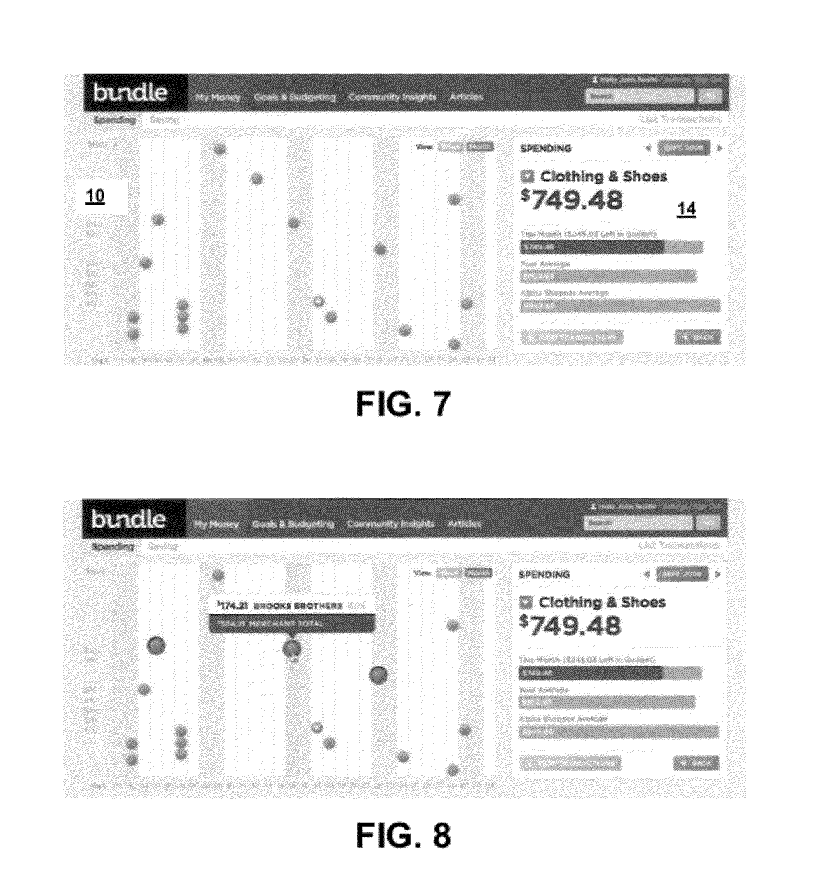

FIG. 4 shows a feature of the illustrated embodiment, where the subcategories of the various categories displayed in area 10 can be identified. By clicking on the All Categories button in area 14, the various categories appear in a drop-down list. The subcategories within each of these categories appears when the pointer scrolls over each category. As shown in FIG. 4, the “Shopping” category is divided into the subcategories of “General Shopping,” “Clothes & Shoes,” “Electronics,” etc. By clicking on one of the categories, the various subcategories are shown in area 10, as illustrated in FIG. 5. In these embodiments, the shapes corresponding to the relative value of the finances related information for each of the subcategories are not linked to the same axis. Alternatively, they are not mathematically tied to a same axis. In some embodiments, any of these subcategories can be further evaluated. In the embodiment illustrated in FIG. 6, scrolling the pointer over a subcategory in area 10 opens a prompt “View over time”. If clicked, the spending in that subcategory over time is illustrated in a graph, e.g., as shown in FIG. 7, at area 10. As illustrated therein, the graph shows purchase dates on the X-axis and amount spent on the Y-axis under the subcategory “Clothing & Shoes”.

Some embodiments of these methods also provide for evaluations of finances data with comparable values for groups that are financially similarly situated. These comparisons can be established by any means. In various embodiments, the user is categorized into a particular user category based on the user finances information provided. In other embodiments, the program asks the user to self-categorize based on descriptions of the various user categories. The values of the finances data for categories or subcategories are then compared to values for those same categories or subcategories of others in the same user group, as determined by publicly available or proprietary surveys.

The above user group comparison is illustrated in area 14 of FIG. 7, which shows a value for “Alpha Shopper Average”. That entry represents the average amount spent on Clothing & Shoes by others in the same group as the user, in this case the “Alpha Shopper” group.

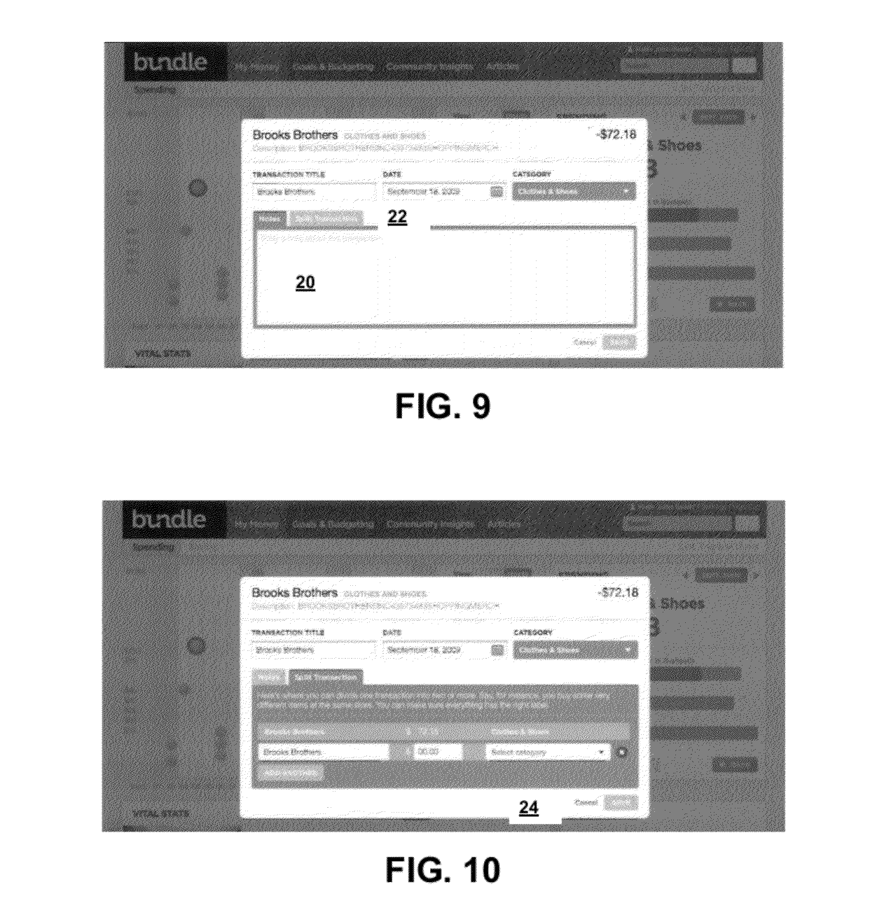

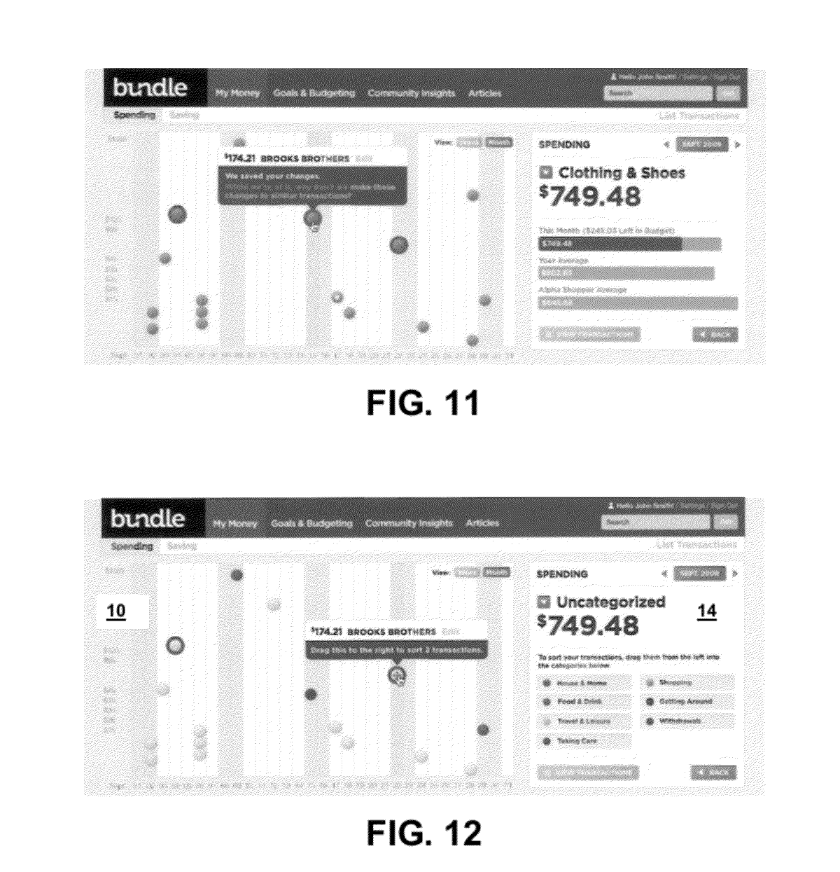

In the illustrated embodiment, the individual purchases graphed in area 10 of FIG. 7 can be further explored by passing the pointer over the circle representing the purchase. That action brings up a label showing details of that purchase, as illustrated in FIG. 8. Clicking on the circle brings up a window for that purchase, as shown in FIG. 9. The window has a box 20 where notation can be made about the purchase, e.g., the specific item(s) purchased or any other information the user wishes to enter. The box also has a tab labeled “Split Transaction” which, if clicked, provides the ability to separate a portion of the purchase into one or more different categories, as shown in FIG. 10. The box can be closed by clicking the “Save” or “Cancel” button 24 at the bottom of the box. Upon saving, the program indicates that the changes made were saved with a flag over the button, as indicated in FIG. 11. The shape representing a purchase is not limited to a circle but can be any shape.

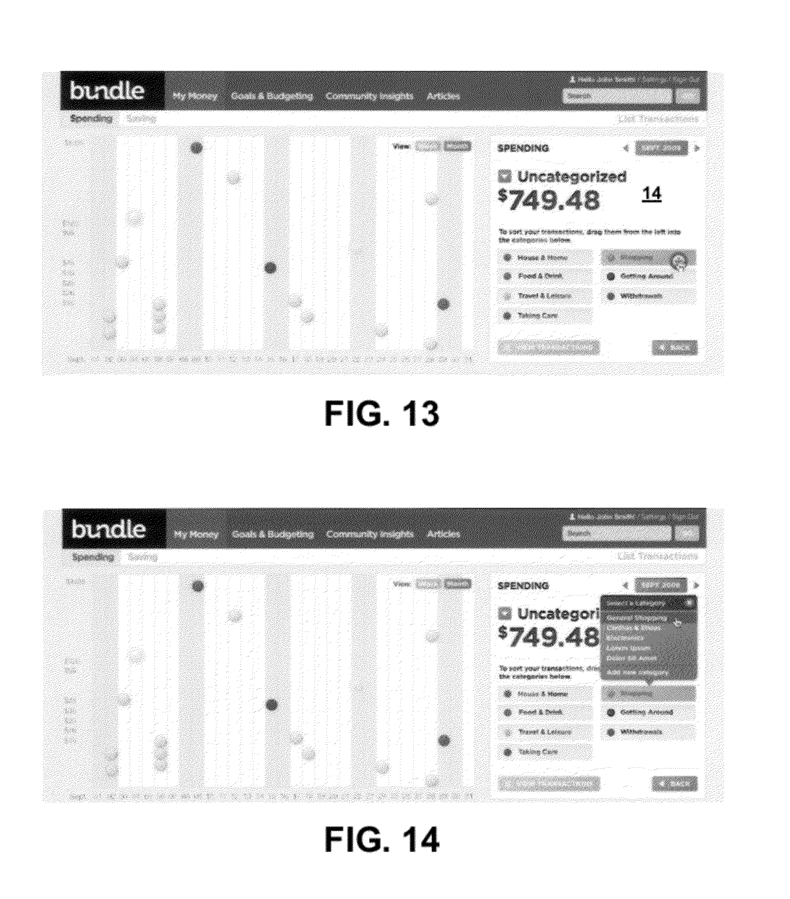

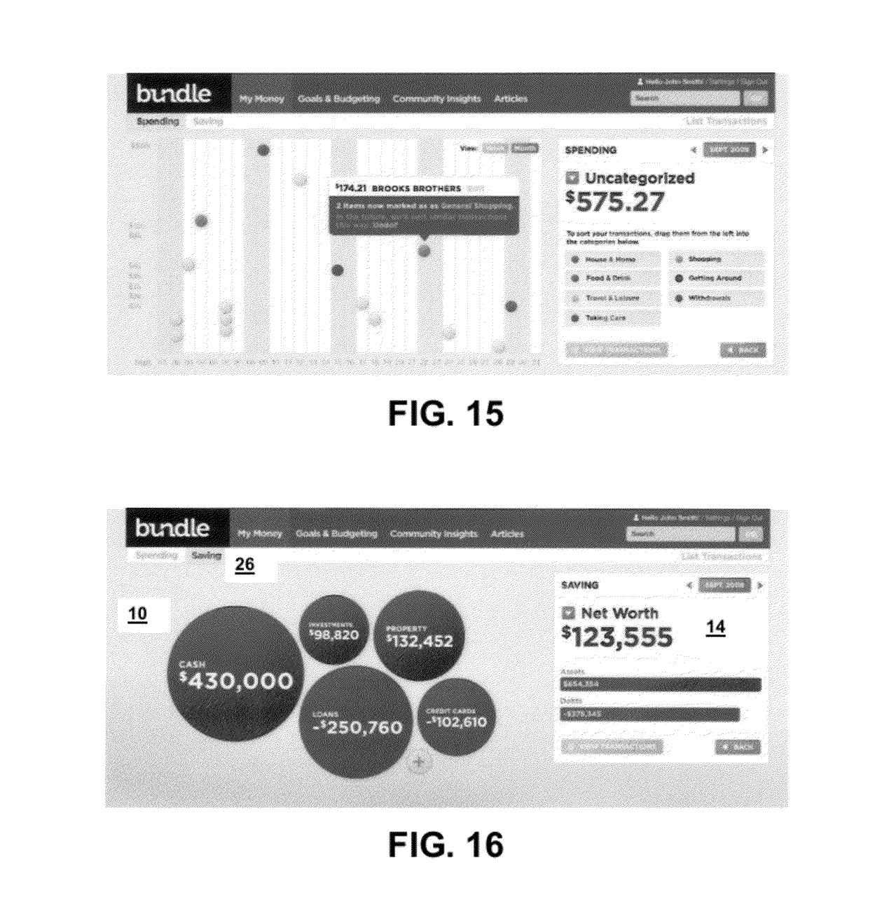

A button representing a purchase can also be sorted into categories by dragging the button from area 10 to area 14, as indicated in FIG. 12. Passing the button to a category listed in area 14, as shown in FIG. 13, activates a drop down menu, allowing the button to be dragged to the category or subcategory under which the purchase is desired, as in FIG. 14. After sorting the purchase, the program labels the button with a description of the change made, as shown in FIG. 15.

As shown in FIG. 16, the illustrated embodiment also provides analysis of the user's net worth, accessed by clicking “Saving” 26 at the top of area 10. Similar to the Spending information described above, various categories of finances data under various financial categories of the user's net worth is shown in shapes of varying size, where the size of each shape corresponds to the relative value of the finances data such that a larger shape corresponds to a larger value. Here the financial categories are Cash, Investments, Property, Loans, and Credit Cards. The shapes can be of various colors, for example, debt, the negative values (here, Loans and Credit Cards) can be red. Area 14 of FIG. 16 provides a net worth listing, divided into Assets and Debts.

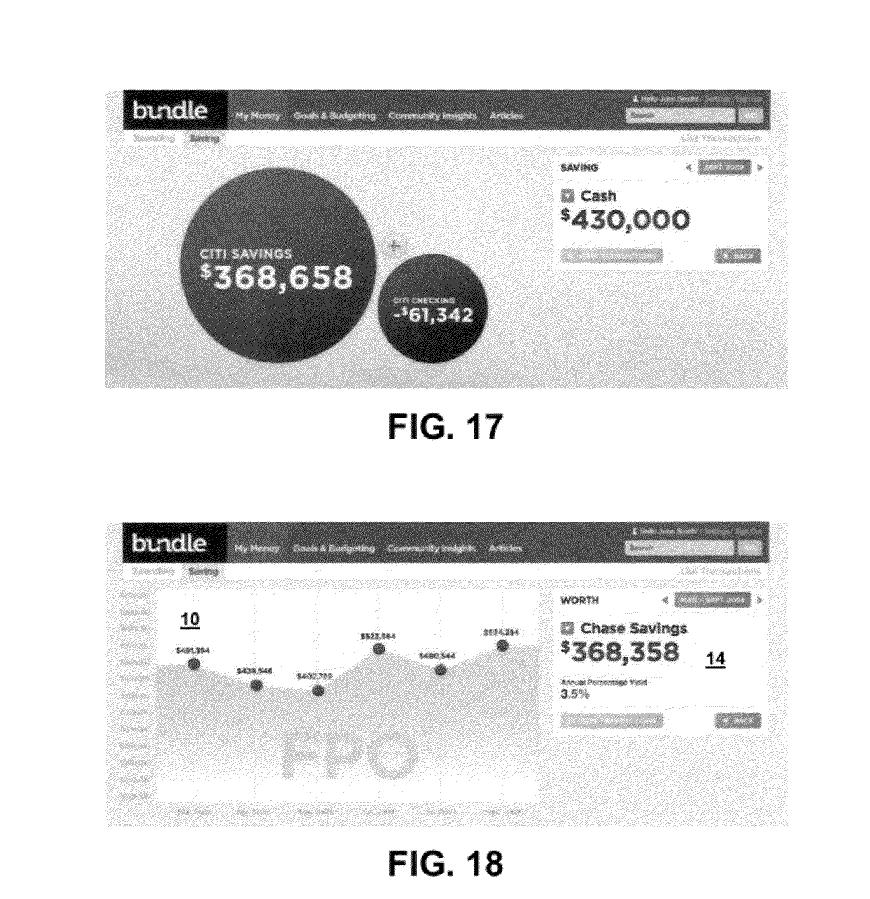

As with the Spending information, each financial category here can be divided into subcategories. As an illustrated example, FIG. 17 shows two subcategories of the “Cash” category, Citi Savings and Citi Checking. By clicking on the shape, a graph showing a change in assets over time is displayed in area 10, and a summary of the subcategory is shown in area 14, as shown in FIG. 18.

Any category in the Savings section can be further detailed. For example,

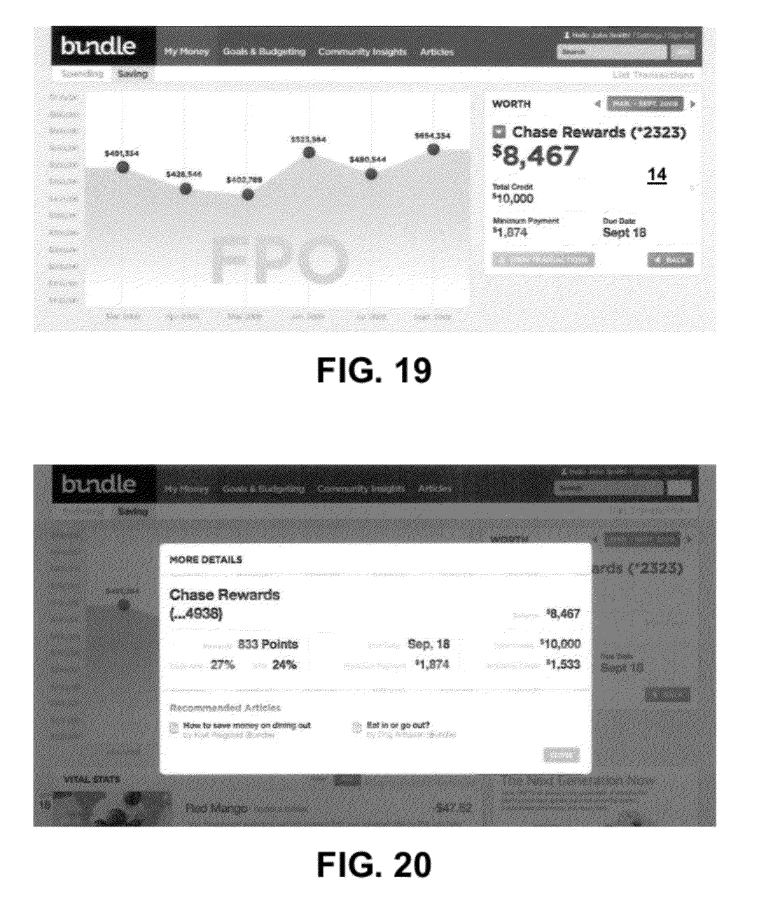

FIG. 19 shows, in area 14, a summary of financial information relating to a “Chase Rewards” credit card, including balance, Total Credit, the Minimum Payment, and Due Date. As shown in FIG. 20, clicking on the button for that entry opens a window showing details of the subcategory, including percentage rate, available credit, and rewards points accumulated. As with similar information in other categories and subcategories, this information can be entered into the system either by user input or by automatically accessing the information from the financial provider (here, Chase) website.

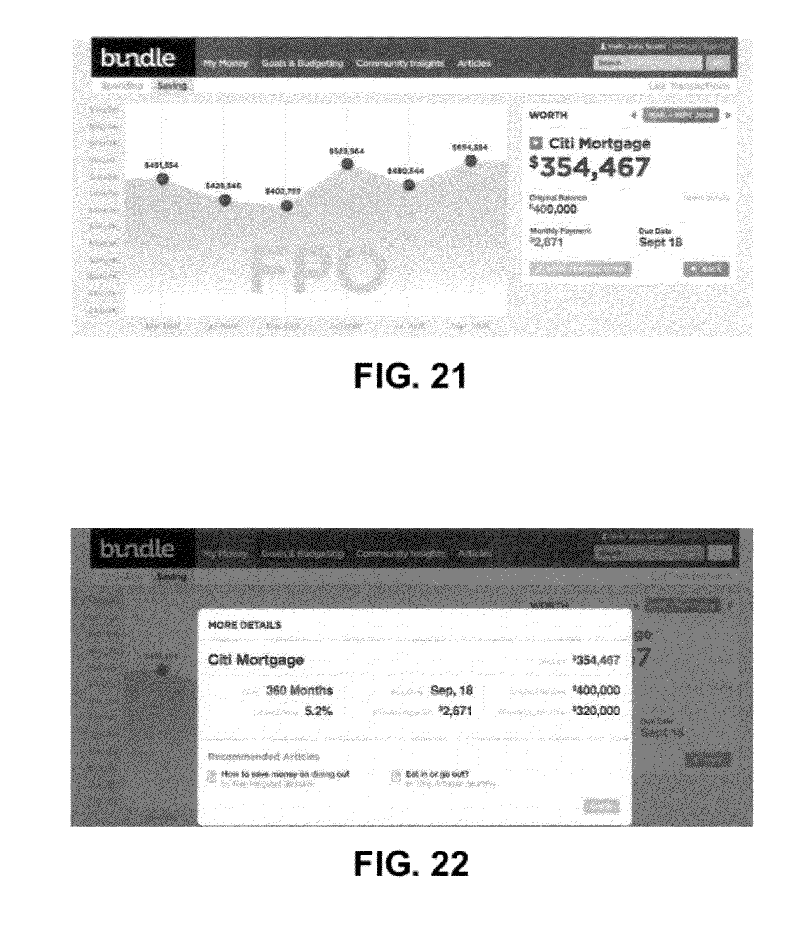

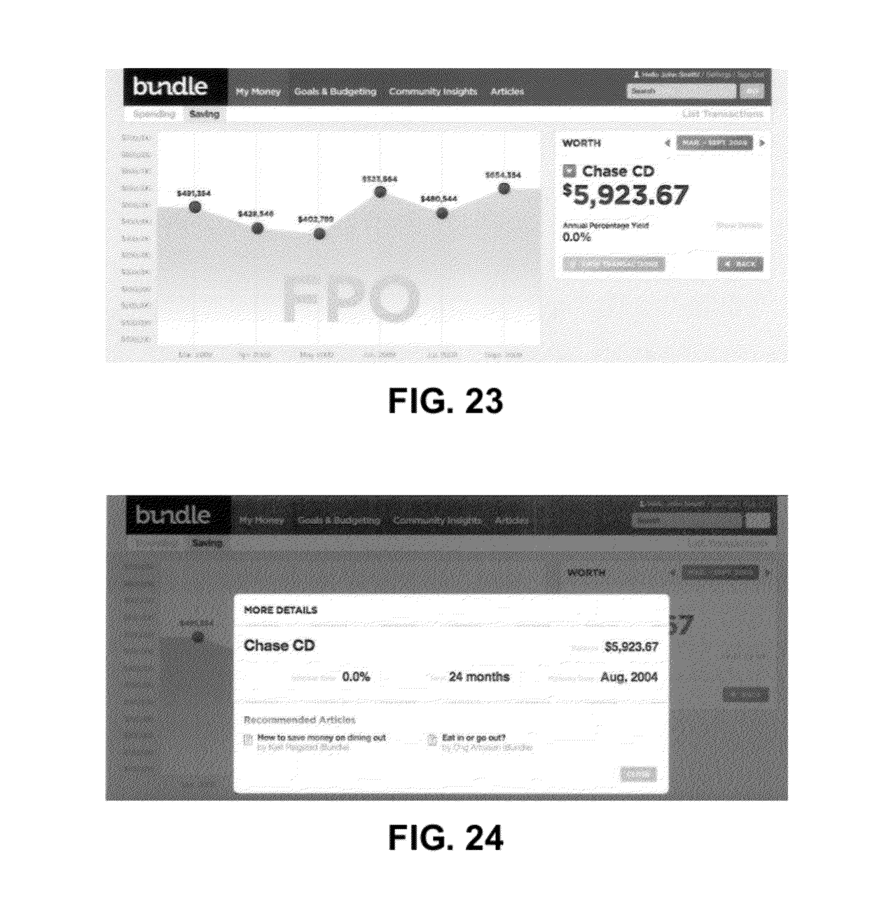

In various embodiments, similar financial information for a mortgage (FIGS. 21 and 22), a certificate of deposit (CD) (FIGS. 23 and 24), or any other investment, loan, etc. can be analyzed.

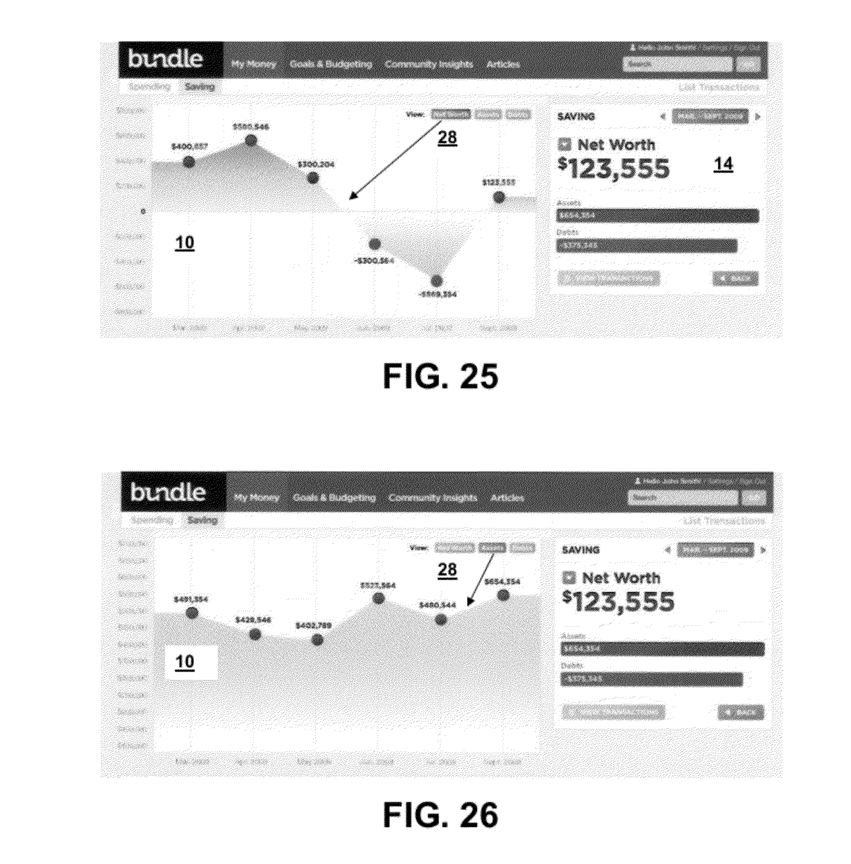

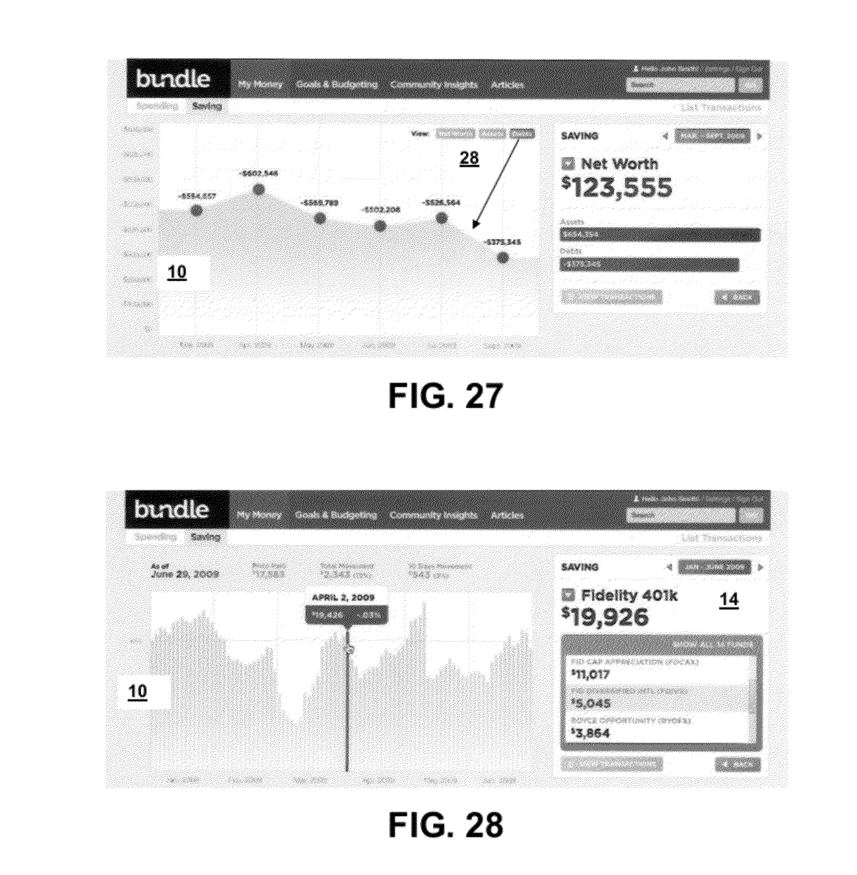

These methods also provide a means to analyze and graph assets, debts and net worth. As shown in FIGS. 25-27, when the category Net Worth is further evaluated, area 10 shows three buttons 28, labeled Net Worth, Assets, and Debts. As shown by the arrows, clicking on the Net Worth button shows a graph of the user's net worth over time in area 10 (FIG. 25). Similarly, clicking on the Assets button shows a graph of the user's assets over time (FIG. 26), and clicking on the Debts button shows a graph of the user's debts over time (FIG. 27).

These methods additionally provide a means for analyzing equities owned by the user. FIG. 28 illustrates an example of a display for that analysis. In area 14, a summary of a Fidelity 401k is provided, showing its value. Below that summary, a window provides a listing of the other mutual funds owned by the user, where any one of the listed funds can be analyzed by clicking on the name of the fund in that window. Area 10 shows a graph of the Fidelity 401k over time, showing gains and losses over the indicated period. Passing the pointer over any date on the graph, as shown for Apr. 2, 2009, prompts the display of a label for that date, showing the user's value in the fund and the change in the value on that day.

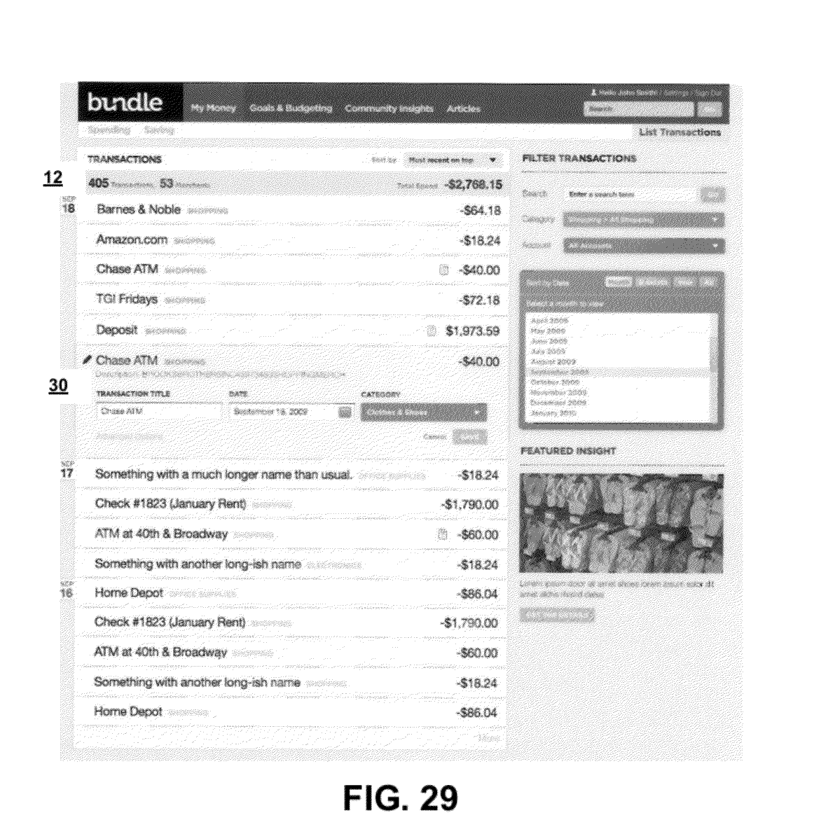

As shown is FIG. 29, individual transactions in a listing of transactions in area 12 can be further analyzed from within that area. For example, by clicking on the Chase ATM entry 30, a summary of the transaction is displayed.

In some embodiments, these methods are performed on an individual computer, for example a home computer. However, the methods can also be advantageously performed over a network, for example the World Wide Web (i.e., the Internet). In those methods, the processor and memory are connected to the display via a network. In those embodiments, the method can access external sources of information, for example accessory information, or bank websites to download user finances information.

Also provided is a system for displaying financial information to a user. The system comprises (a) a processor, wherein the processor (i) runs a software application that obtains financial category information for a plurality of financial categories, and user finances information categorized into the plurality of financial categories; and (ii) determines finances data in each of the plurality of financial categories. The finances data of a financial category in these embodiments includes the user finances information in that category. The system also comprises (b) a database coupled to the processor. The database resides in at least one memory and stores the user finances information and the financial category information. Additionally, the system comprises (c) a display coupled to the processor. The processor causes the finances data corresponding to the plurality of financial categories to be presented to the user on the display in the form of shapes of varying sizes. In various embodiments, the size of each shape corresponds to the relative value of the finances data for the corresponding demographic category such that a larger shape corresponds to a larger value. Further, the shapes are not mathematically tied to a same axis.

This system performs the methods described above, and feature all of the characteristics of those methods.

Additionally provided is a computer program product to be used with a processor and a display. The computer program product comprises a computer usable medium comprising computer readable program code directing the processor to obtain financial category information for a plurality of financial categories; obtain user finances information categorized into the plurality of financial categories; store the financial category information and the user finances information in a memory; determine a value for finances data in each of the plurality of financial categories, wherein the finances data of a financial category includes the user finances information in that category; and show on the display the determined value of the finances data in each of the plurality of financial categories in the form of a shape for each value. In various embodiments, the computer readable program code specifies that the size of each shape corresponds to the relative value of the finances data for the corresponding financial category such that a larger shape corresponds to a larger value; and the shapes are not mathematically tied to a same axis.

This computer program product executes the system and methods described above, featuring all of the characteristics of that system and those methods. The computer program can reside on an individual computer such as a home computer. Alternatively, the computer program can reside on a computer server remote from the display and the user.

As indicated in FIG. 1, the methods described herein are practiced on a computer through the interaction of the user with a computer program. The interaction can operate using any computer system available. For example, the processor of FIG. 1, along with the display, can be on a laptop, desktop or handheld (e.g., Smartphone or iPad-type device) computer accessed by the user. Alternatively, the processor can be at a remote location, e.g., a server accessed by the user over the Internet. The computer program could also utilize the processor accessed by the user for some tasks and a remote processor for other tasks. Similarly, the memory utilized in the methods, systems and computer programs described herein can be on the computer accessed by the user, on a computer at a remote location, or both (i.e., some memory functions utilized on the user's computer and other memory functions utilized on a remote server). The data accessed in the methods (e.g., financial category information, user finances information, calculated finances data, accessory information, passwords, etc.) can also be stored on a remote computer and/or the user's computer. In some embodiments, the data is stored on a remote computer and the user's computer only accesses and stores data while it is being analyzed, utilized and/or displayed by the display on the user's computer.

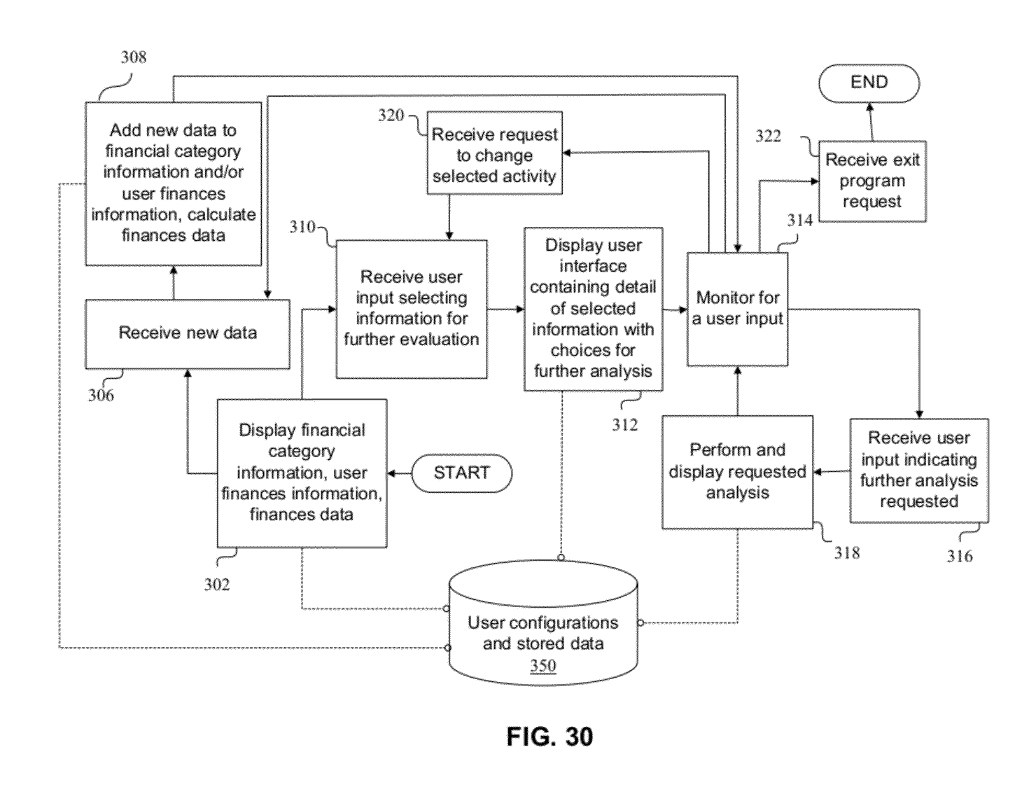

FIG. 30 summarizes the flow of information in some embodiments of the disclosed methods, systems and computer programs. The user configurations and stored data reside on a data storage device or memory 350, on the computer that the user is operating or at a remote location, e.g., connected to the user's computer through the Internet, or both. Upon starting, the program displays financial information, user finances information and calculated finances data 302. If new information is received 306, e.g., by user input or by the processor retrieving information from a database, the processor adds the new data to the financial category information and/or the user finances information, and calculates any appropriate changes to the finances data resulting from the new data 308. The program is also capable of receiving user input selecting information for further evaluation 310, and responds by displaying a user interface containing details of the selected information with choices for further analysis 312, then monitors for a user input 314. The input results in (a) the receipt of new data 306, (b) the receipt of a request to change the selected activity 320, (c) a request for further analysis 316, or (d) a request to exit the program 322, the latter action resulting in an end to the session. If further analysis is requested 316, the program performs and displays the requested analysis 318.

Computer program instructions for executing the disclosed embodiments may be stored in a computer-readable medium that can direct a computer or other programmable data processing apparatus to function in a particular manner, such that the instructions stored in the computer-readable medium produce instruction means which implement the function/act specified in the flowchart. The computer program instructions may also be loaded onto a data processing apparatus to cause a series of operational steps to be performed on the data processing system to produce a computer implemented process such that the instructions which execute on the data processing system provide processes for implementing the functions/acts specified in FIGS. 1 and 30 and as described above.

Embodiments involving computer software and hardware generally execute algorithms which implement method embodiments. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the present disclosure, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various embodiments may be implemented with the aid of computer-implemented processes or methods (a.k.a. programs or routines) that may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

Embodiments may be implemented with apparatus to perform the operations described herein. This apparatus may be specially constructed for the required purposes, or may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

One of ordinary skill in the art will immediately appreciate that the teachings of the present disclosure may be practiced with computer system configurations other than those described above, including hand-held devices, multiprocessor systems, microprocessor-based or programmable consumer electronics, DSP devices, network PCs, minicomputers, mainframe computers, and the like, as well as in distributed computing environments where tasks are performed by remote processing devices that are linked through a communications network.

Other embodiments within the scope of the claims herein will be apparent to one skilled in the art from consideration of the specification or practice of the invention as disclosed herein. It is intended that the specification be considered exemplary only, with the scope and spirit of the invention being indicated by the claims.

In view of the above, it will be seen that the several advantages of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

1. A method implemented using a processor, a memory and a display device for displaying financial information to a user, the method comprising:
obtaining user finances information;
obtaining financial category information for a plurality of financial categories;
storing the user finances information and financial category information in the memory;
determining a value for finances data in each of the plurality of financial categories using the processor, wherein the finances data of a financial category includes the user finances information in that category; and
displaying the determined value of the finances data in each of the plurality of financial categories in the form of a shape for each value,
wherein the size of each shape corresponds to the relative value of the finances data for the corresponding financial category such that a larger shape corresponds to a larger value; and
wherein the shapes are not mathematically tied to a same axis.

2. The method of claim 1, wherein each of the financial categories represents a category of user purchases, debt, savings, investment, loan, credit card, or financial account.

3. The method of claim 1, wherein the finances data of a financial category is the sum of the user finances information in that category.

4. The method of claim 1, wherein at least a portion of the user finances information and/or the financial categories information is obtained by requesting input from the user on the display device.

5. The method of claim 1, wherein at least a portion of the user finances information and/or the financial categories information is obtained from at least one database.

6. The method of claim 5, wherein the database comprises a statement of a financial account of the user.

7. The method of claim 1, wherein the shapes are represented by a single type of shape.

8. The method of claim 7, wherein the type of shape is a circle, an oval, a square, a rectangle, a triangle, a pentagon, a hexagon, a heptagon, an octagon, or a parallelogram.

9. The method of claim 7, wherein the type of shape is a circle.

10. The method of claim 7, wherein the type of shape is a rectangle having a length and a width, wherein the length of the rectangle increases and the width does not increase as the rectangle represents a larger value of finances data.

11. The method of claim 1, wherein the shapes of varying sizes are represented by more than one type of shape.

12. The method of claim 11, wherein the more than one type of shape are selected from the group consisting of a circle, an oval, a square, a rectangle, a triangle, a pentagon, a hexagon, a heptagon, an octagon, and a parallelogram.

13. The method of claim 1, wherein the circumferences of the shapes of varying sizes do not intersect or touch.

14. The method of claim 1, wherein each shape is colored with a color that is unique for the corresponding financial category.

15. The method of claim 1, wherein at least one of the financial categories is divided into a plurality of subcategories, each subcategory representing a different financial subcategory comprising user finances information within the financial category.

16. The method of claim 15, further comprising
(a) determining the value of finances data corresponding to each of the plurality of subcategories using the processor;
(b) displaying the values calculated under (a) in response to a user request, wherein the values are displayed in the form of a shape for each value,
wherein the size of each shape corresponds to the relative value of the finances data corresponding to each of the plurality of subcategories such that a larger shape corresponds to a larger value.

17. The method of claim 16, wherein the finances data of a subcategory is the sum of the user finances information in that subcategory.

18. The method of claim 15, wherein the subcategories are temporal divisions.

19. The method of claim 15, wherein the subcategories are classes of a category of an expense.

20. The method of claim 16, wherein the user request is made by moving a cursor to the shape of the financial category under which the subcategory is divided, and activating a link residing on the shape.

21. The method of claim 16, wherein the shapes corresponding to the relative value of the finances data for each of the subcategories are not mathematically tied to the axis.

22. The method of claim 15, wherein the user demographic subcategories are a plurality of subcategories of user purchases, debt, savings, investments, loans, credit cards or financial accounts.

23. The method of claim 22, wherein the user demographic categories include classes of purchases, which classes of purchases include shopping, travel, home expenses, and food.

24. The method of claim 1, further comprising
determining a budgeted value for a designated time period for each of the plurality of financial categories and storing each of the budgeted values in the memory.

25. The method of claim 24, further comprising displaying the budgeted value for each of the plurality of financial categories in the form of a shape for each value,
wherein the size of each shape corresponds to the relative value of the budgeted value for the corresponding financial category such that a larger shape corresponds to a larger budgeted value; and
wherein the shapes are not mathematically tied to a same axis.

26. The method of claim 25, wherein the shape corresponding to the budgeted value is filled with a color in proportion to the degree that the user reaches the budget for the designated time period.

27. The method of claim 24, wherein the budgeted value is provided by the user in response to a request for input on the display device.

28. The method of claim 24, wherein the budgeted value is calculated based on (a) prior user activity and/or (b) user demographic information comprising income, age, geographic location, interests, and/or health status, and comparative population data for that demographic information.

29. The method of claim 24, further comprising comparing the budgeted value for each financial category with the finances data for that financial category and, if the budgeted value for any financial category is less than the finances data for that financial category, displaying a message to the user relating thereto.

30. The method of claim 29, wherein the message informs the user that the finances data exceeds the budgeted value.

31. The method of claim 29, wherein the message directs the user to accessory information relating to reducing expenses for the financial category.

32. The method of claim 1, wherein the processor and memory are connected to the display via a network.

33. A system for displaying financial information to a user, the system comprising:
(a) a processor, wherein the processor
(i) runs a software application that obtains
financial category information for a plurality of financial categories, and
user finances information categorized into the plurality of financial categories; and
(ii) determines finances data in each of the plurality of financial categories, wherein the finances data of a financial category includes the user finances information in that category;
(b) a database coupled to the processor, wherein the database resides in at least one memory and stores the user finances information and the financial category information; and
(c) a display coupled to the processor, wherein the processor causes the finances data corresponding to the plurality of financial categories to be presented to the user on the display in the form of shapes of varying sizes, wherein
the size of each shape corresponds to the relative value of the finances data for the corresponding financial category such that a larger shape corresponds to a larger value, and
the shapes are not mathematically tied to a same axis.

34. A computer program product to be used with a processor and a display, the computer program product comprising:
a computer usable medium comprising computer readable program code directing the processor to obtain financial category information for a plurality of financial categories;
obtain user finances information categorized into the plurality of financial categories;
store the financial category information and the user finances information in a memory;
determine a value for finances data in each of the plurality of financial categories, wherein the finances data of a financial category includes the user finances information in that category; and
show on the display the determined value of the finances data in each of the plurality of financial categories in the form of a shape for each value,
wherein the computer readable program code specifies that
the size of each shape corresponds to the relative value of the finances data for the corresponding financial category such that a larger shape corresponds to a larger value; and
the shapes are not mathematically tied to a same axis.
